(19) United States
(12) Patent Application Publication
(10) Pub. No.: US 2023/0037387 A1
(43) Pub. Date: Feb. 9, 2023

(54) DEVICE FOR COMBINING SEVERAL LIGHT BEAMS

(71) Applicants: COMMISSARIAT À L'ÉNERGIE ATOMIQUE ET AUX ÉNERGIES ALTERNATIVES, PARIS (FR); ECLYPIA, GRENOBLE (FR)

(72) Inventors: Cyrielle MONPEURT, GRENOBLE (FR); Jean-Guillaume COUTARD, GRENOBLE (FR); Olivier LARTIGUE, GRENOBLE CEDEX 9 (FR)

(21) Appl. No.: 17/880,205

(22) Filed: Aug. 3, 2022

(30) Foreign Application Priority Data
Aug. 5, 2021 (FR) 2108518

(51) Int. Cl. G02B 6/42

(52) U.S. Cl. CPC G02B 6/4203

(57) ABSTRACT

A device for combining several light beams, the device including several hollow input waveguides, at least one per light beam, as well as a hollow output waveguide which is the same for the different light beams, each input waveguide having an input opening to let the corresponding light beam enter, and, at the opposite, an output opening through which it emerges in the output waveguide, the output waveguide, as well as each input waveguide being laterally delimited by one or more metallic reflecting surfaces, and wherein at least a section of the output waveguide is divergent and widens in the direction of an output opening of the output waveguide.

### CROSS-REFERENCE TO RELATED APPLICATIONS

This application claims priority to French Patent Application No. 2108518, filed Aug. 5, 2021, the entire content of which is incorporated herein by reference in its entirety.

### FIELD

The technical field is that of devices for combining several light beams together in order to obtain the same global light beam, in particular in the mid-infrared range.

### BACKGROUND

Combining several light beams together that is to superimposing them at least partially with one another, for example so that they illuminate together the same given zone (which can be a zone to be imaged, to be characterised, or to be processed). For this, the beams must be brought closer to one another, from a lateral standpoint (i.e.: in terms of lateral position) and, if possible, one should also bring their respective directions of propagation closer together.

Combining several beams as such makes it possible for example to increase the total power with which the zone in question is illuminated, or to have a kind of redundancy between several light sources (in order to improve the reliability of the device). But above all this makes it possible to combine several light beams emerging from sources that have different emission spectra, for example laser sources having different emission wavelengths. The global light beam thus obtained then covers a wide range of wavelengths while still having a high brightness.

Such a combination of beams is particularly useful in the near- and mid-infrared range (vacuum wavelength comprised between 1 and 15 microns, for example). Indeed, this wavelength range is particularly favorable for detecting chemical compounds, with many applications in the medical field, in the field of agronomy or in that of defence and safety. And delivering several different mid-infrared wavelengths thus make it possible to detect several different compounds.

To combine several light beams, a solution consists of using a dispersive element such as a diffraction grating. But such a system, with free propagation of the beams, is generally rather cumbersome (in particular because a prior collimation of the beams is required), and therefore hardly adapted a priori to a portable or integrated device.

Another solution consists of using upon-silicon waveguides manufactured by techniques derived from microelectronics. This can be for example Germanium guides, with a Silicon and Germanium alloy cladding. The guiding of the light therein is then carried out by total internal reflection. In such a system, to combine several beams, it is possible to use a device where several guides join together, in general in a zone that forms a bottleneck (a kind of funnel), to connect at the input of an output waveguide, which is the same for the different beams. Such a device has the advantage of being suitable to be miniaturised. But it is not very interesting from a loss standpoint, because about half of the power is lost at each junction between two guides. In addition, the lateral dimensions of the guides are particularly small (generally about 10 microns at most) and render the injection in these guides difficult because they require a very precise alignment of the sources with respect to the guides (precision of about 100 nm, according to the three directions in space, which is very restrictive), all the more so that laser sources that emit in the mid-infrared are often semiconductor-based sources with a very small active zone, for which the divergence of the emitted beams is very high, at the output of the source. To combine these beams, it is also possible to use a dispersive element such as a diffraction grating, in particular a grating of the concave planar grating type (CPG) carried out on the substrate that supports the guides, or to use a grating with a base of integrated waveguides of the “Arrayed Wave Guide Grating” type. But such a solution can be used only if the beams have different wavelengths, and even wavelength very different from one another. And once the device is carried out, it is difficult and even impossible to modify the wavelengths in question. In addition, such a device requires, again, high alignment precision.

Yet another solution for combining several light beams in the mid-infrared range, based on hollow metal waveguides milled on the upper face of an aluminium block, was proposed in the following article: “iBEAM: substrate-integrated hollow waveguides for efficient laser beam combining” by Julian Haas et al., Optics Express, vol. 27, no. 16, 2019, pp. 23059-23066. The aluminium block in question has sides about 5 cm by 5 cm, fora thickness of 2 cm. The device comprises 7 input waveguides, each one provided at the input with a connector of the F-SMA type to connect an optical fibre. These guides each have an approximately square section with 2 mm sides. They come together at a globally converging junction zone (see FIG. 1.a of this article) which ends with an output waveguide which is the same for the different light beams. The output port of this device is equipped with a part in the shape of a funnel, made of polished aluminium, which allows for a passage, from the output waveguide with a square section with 2 mm sides, to an output optical fibre having a core with a 0.8 mm diameter. This device is robust, and adapted to combine, in the same output optical fibre, several light beams initially transported in different input optical fibres.

But this hollow beam combiner, designed to operate with optical fibres connected as input and as output, delivers at the output a light beam that is generally not adapted to directly illuminate a scene or a sample to be characterised (for example a small portion of the skin of an individual, a section of a leaf of a plant or a portion of a material to be analysed). Indeed, at the output of the part in the shape of a funnel mentioned hereinabove, the global light beam is of small section (just at the output of the funnel) and probably highly divergent. In addition, the passage from the optical fibres to the hollow metal guides is accompanied by a loss in optical power (of about 6 dB), at the output of the device. This device moreover has a transmission which is globally low in the mid-infrared, with losses of 10 dB for propagating through the device, for each light beam.

### SUMMARY

In this context, in an aspect of the invention, a device for combining several light beams is proposed, the device comprising several hollow input waveguides, at least one per light beam, as well as a hollow output waveguide which is the same for the different light beams,
each input waveguide having an input opening to let the corresponding light beam enter, and, at the opposite, an output opening, the input waveguide leading to the output waveguide through the output opening of the input waveguide,
the output waveguide, as well as each input waveguide being laterally delimited by one or more metallic reflecting surfaces,
and wherein at least a section of the output waveguide is divergent and widens when moving towards an output opening of the output waveguide.

Formulated differently, at least a section of the output waveguide, for example its end section, is divergent and widens in the direction of propagation of the light beams.

In practice, the light beams that enter the device are generally highly divergent (for example because they emerge directly from laser diodes). However, the inventors have observed that the divergent section of the output waveguide, that widens in the direction of the output of the device (instead of narrowing), makes it possible to clearly reduce the divergence of the individual light beams. Such a divergent section thus has an effect that is partially comparable to that of a convergent mirror. Moreover, it has been shown that such an output waveguide, that widens when moving towards the output, brings closer together the respective directions of propagation of these different light beams to be combined. By way of comparison, with an output waveguide with parallel edges, in fact, the different specular reflections on the edges of the guide do not make it possible to bring closer together the respective directions of propagation of the different light beams, which then remain separated from one another from an angular standpoint (just like they are before propagating through such a waveguide).

Using such an output waveguide, that widens in the direction of propagation of the light beams, therefore makes it possible to obtain at the output a global light beam, grouping all the input light beams together, which has an overall reduced divergence. This divergent section further makes it possible to obtain a high power per unit area, and relatively homogeneous over the entire beam.

The device that has just been presented can also comprise a convergent mirror on which the light beams reflect, after emerging from the output waveguide. This convergent mirror further reduces the divergence of the global light beam in question.

The inventors have moreover observed that such a mirror, associated with the output waveguide with a divergent section, makes it possible to obtain in the end an intense and homogeneous illumination of a zone to be illuminated, when combining the different light beams in question (see FIGS. 5 to 8). To illuminate a sample or a medium to be characterised, the global light beam thus produced is moreover clearly more suitable than the one that would be obtained with a convergent mirror but without the divergent portion of the output waveguide (see FIGS. 9 to 12), and this even when optimising the characteristics of the convergent mirror in question.

This association of the convergent mirror with the output waveguide with a divergent section makes it possible in particular to obtain a light power per unit area that is homogeneous over an entire zone to be illuminated, at the output of the device, and this for each one of the individual input light beams (i.e. in the presence of only one of the light beams, then in the presence of another of these beams only, and so on). In addition, the light power transported by one or the other of these light beams is mostly located inside this zone to be illuminated.

The characteristics of the convergent mirror are in general determined according to the characteristics of the output waveguide with a divergent section, with which this mirror is associated (in order to obtain an optimum cooperation between these two elements).

In any case, this device for combining, with this output waveguide with a divergent section, allows for an effective combining of several light beams.

This particular arrangement makes it possible moreover to improve the compactness of the device: from several different sources, which can be non-collimated, a global light beam is directly obtained, that combines the input light beams and that is semi-collimated, and this without having recourse to other optical components.

It is interesting to produce such a beam, collimated, or at the least semi-collimated, because this makes it possible to illuminate a sample to be characterised with rays that have almost the same incidence, and therefore the same characteristic penetration depth in this sample (in any case for a homogeneous sample). This thus makes it possible to probe a given, well controlled thickness of the sample (for example a thickness of a biological tissue).

In addition, the optical losses that could result in a coupling in an output optical fibre, or from input optical fibres are thus avoided.

One may further note that in such a device for combining, with hollow metal waveguides, the losses by injections can be very low, and the losses by a possible curvature of the guides is practically absent (contrary to guides made from dielectric material). The reflections on the metal surfaces that delimit the guides can however cause losses by absorption, a loss that however remains moderate since many metals have a high reflectivity, in particular in the infrared. Finally, such a device resists high fluxes, generally more than of waveguides made from dielectric materials. Most, or even all of each waveguide can be delimited laterally by one or more metallic reflecting surfaces.

The input and output waveguides can each be delimited, laterally, by a single reflecting surface when the waveguides are cylindrical, for example. Each guide can also be delimited laterally by several separate reflecting surfaces, when this guide has a square or rectangular section for example (in which case it is delimited by four lateral reflecting surfaces). Throughout this document, the term “section”, when not referring to a portion of the guide, designates a cross-section (a cross-section view) of the waveguides considered, according to a section plane perpendicular to the axis of the guide (or more generally, perpendicular to an average line along which the guide extends; in other terms, this is a straight cross-section view). Moreover, the input (or output) waveguides, will be designated indifferently by the expression “input waveguide” or by the expression “input guide”.

In addition to the characteristics mentioned hereinabove, the device that has just been presented can have one or more of the following optional characteristics, taken individually or according to any technically permissible combinations:
the divergent section has an average opening angle higher than 20 degrees;
the opening angle is comprised between 20 degrees and 100 degrees (which corresponds for example to plus or minus 10 degrees, and, respectively, plus or minus 50 degrees on either side of an axis of the output waveguide, on which this guide is centred); for connecting angles of the input waveguides on the output waveguide comprised typically between 10 and 50 degrees, such opening angle values are well suited for obtaining at the output a global pseudo-collimated light beam, wherein the directions of propagation of the individual initial light beams will have been brought closer to one another;
the average opening angle is the average opening angle that this divergent section has in a plane containing the axis of the output waveguide (or in a plane containing an average line along which the output waveguide extends);
the opening angle is equal to the average angle between two of the metallic reflecting surfaces, which laterally delimit the output waveguide at said divergent section, these two surfaces being respectively located on either side of the guide (said average being an average along said divergent section);
the opening angle is equal to the angle between two planar reflecting metal surfaces that laterally delimit the output waveguide at said divergent section, with these two surfaces being located respectively on either side of the guide;
the output opening of the output waveguide has an area that is at least higher than twice, or even higher than three times the area of an input section of said divergent section;
the input waveguides and the output waveguide extend parallel to a same plane; formulated otherwise, the output waveguide and each input waveguide extends along an average line, on which it is centred, with these different average lines being located in the same plane, or, at the very least, extending parallelly to a given plane that is the same for the different guides; the output waveguide and the input waveguides can for example be centred respectively on different axes, which are each parallel to this same plane, or even located in this same plane;
the device further comprises a deflecting mirror arranged to reflect the light beams emerging from the output waveguide in an averaged direction tilted with respect to said plane;
the angle between said averaged direction and said plane is comprised for example between 40 and 90 degrees;
the deflecting mirror is the convergent mirror itself; in other terms, the deflecting mirror and the convergent mirror can be a single and same mirror, both convergent and tilted;
the deflecting mirror is arranged facing the output opening of the output waveguide;
the device comprises a base with an upper surface, and a cover with a lower surface that is in contact with the upper surface of the base, the base comprising, on its upper surface several grooves, each input waveguide being formed, at least partially, by one of said grooves; formulated differently, each input waveguide is constituted at least partially by one of these grooves;
the base and/or the cover is a monolithic part, of a single piece (this improves the stability and the compactness of the device);
the device comprises several light sources for emitting said light beams, each light source being placed so that the light beam emitted by this source enters one of the input waveguides of the device;
the sources are rigidly bound to the input waveguides;
for at least some of said sources, the light beam emitted by the considered source directly enters the corresponding input waveguide, without any intermediate optical component between the source and the input opening of this waveguide;
for at least some of said sources, the device comprises one or more intermediate optical components located on the path of the light beam emitted by the source considered, between this source and the input opening of the corresponding input waveguide;
for at least some of said sources, the light beam emitted by the source considered has an average wavelength (vacuum wavelength) comprised between 1 and 15 microns;
the device comprises at least one input mirror, to reflect the light beam emitted by one of said sources towards the input opening of the corresponding input waveguide, a direction perpendicular to this mirror being tilted with respect to said plane (when the input mirror is not a flat mirror, said perpendicular direction is the direction that, on the average, is perpendicular to this mirror—average on the illuminated section of the mirror);
at least some of the input waveguides have a section of which the width or the diameter is comprised between 0.1 and 1.5 mm, even between 0.1 and 0.7 mm;
at the input of the input waveguides, the light beams emitted by said sources each have an opening angle higher than 20 degrees, even higher than 40 degrees;
after reflection on said convergent mirror, said light beams emerge from the device without encountering any other optical component, except for a possible planar filter and/or a possible planar output window crossed by these light beams to emerge from the device.

The instant technology and its different applications will be understood better when reading the following description and when examining the accompanying figures.

### BRIEF DESCRIPTION OF THE FIGURES

The figures are presented for the purposes of information and are in no way limiting.

FIG. 1 schematically shows a first embodiment of a device for combining beams implementing the instant technology, viewed in perspective.

FIG. 2 schematically shows a beam combiner of the device of FIG. 1, viewed in perspective and by transparency.

FIG. 3 is identical to FIG. 2, but shows some dimensions of the combiner.

FIG. 4 shows in more detail an output mirror of the device of FIG. 1, in perspective.

FIG. 5 schematically shows, in perspective, light rays propagating in the device of FIG. 1, these rays being obtained by digital simulation.

FIGS. 6, 7 and 8, obtained by digital simulation, show the irradiance obtained in a given zone to be illuminated, at the output of the device of FIG. 1, when a first, second and respectively third source is in operation, the other sources being switched off.

FIG. 9 is similar to FIG. 5, but in the case of an output waveguide without a divergent section.

FIGS. 10, 11 and 12 are similar respectively to FIGS. 6, 7 and 8 but, here again, in the case of an output waveguide without a divergent section

FIG. 13 schematically shows a second embodiment of a device for combining beams implementing the instant technology, viewed in perspective.

FIG. 14 schematically shows a third embodiment of a device for combining beams implementing the instant technology, viewed in perspective.

### DETAILED DESCRIPTION

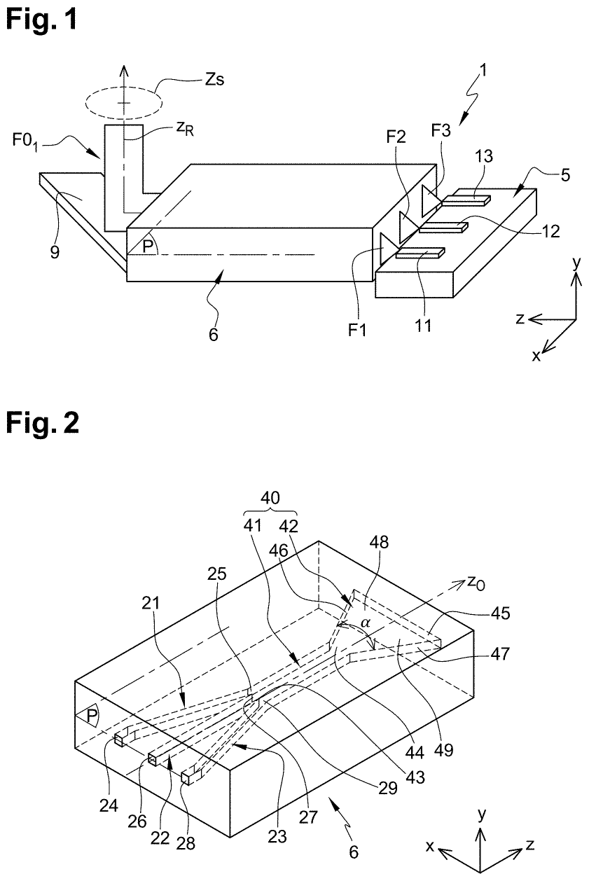

As already mentioned, the instant technology relates to a device 1; 2; 3 for combining together several input light beams, F1, F2 and F3, in such a way as to obtain at the output the same global light beam, for example semi-collimated (see FIGS. 1, 13 and 14). This combination is carried out using a set of hollow metal waveguides.

This set comprises input waveguides 21, 22, 23 (FIG. 2), one per input light beam F1, F2, F3. These input waveguides each emerge in the same output waveguide 40, which is the same for the different light beams F1, F2, F3, making it possible to combine them.

Remarkably, at least one section of the output waveguide 40 is divergent and widens in the direction of an output opening 45 of this guide. As explained in the part entitled “summary”, the fact that this waveguide widens as such, in the direction of propagation of the light beams, makes it possible to reduce the divergence of the global light beam F0₁; F0₂; F0₃ that emerges therefrom.

Three embodiments of this device, which respectively bear the reference number 1, 2 and 3, are shown respectively in FIGS. 1, 13 and 14.

In the first embodiment, the device 1 comprises an output mirror 9 on which the global light beam F0₁ is reflected, after emerging from the hollow waveguide system (FIGS. 1, 4 and 5). This output mirror 9 is convergent, in order to further reduce the divergence of the beam F0₁. It is moreover tilted, in such a way as to deviate the global light beam F0₁ towards a zone to be illuminated Zs located outside the axis.

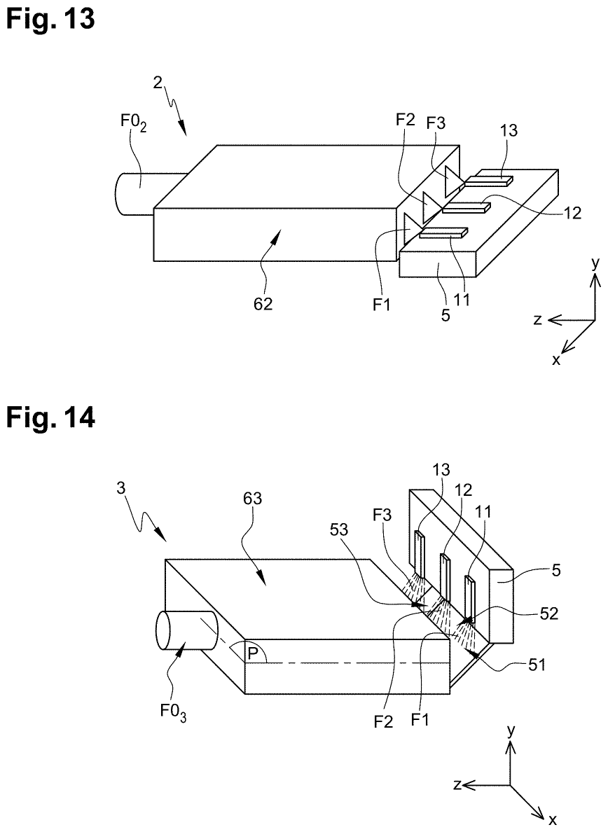

In the second embodiment, the device 2 is devoid of such an output mirror (FIG. 13).

In the third embodiment, the device 3 is devoid of such an output mirror but on the other hand comprises one input mirror 51, 52, 53 for each input light beam F1, F2, F3 (FIG. 14). These input mirrors are tilted, in such a way as to direct these light beams towards the input waveguides 21, 22, 23, the light beams F1, F2, F3 being initially emitted with emission directions tilted with respect to the plane P wherein the waveguides extend (FIG. 14).

These three embodiments however have many points in common (in particular relating to the arrangement of the waveguides). Thus, identical or corresponding elements will as much as possible be marked with the same reference signs, from one embodiment to another, and they will not necessarily be described each time. These three embodiments are now described in more detail, one after the other.

### First Embodiment

Different aspects of the device 1 according to the first embodiment can be seen in FIGS. 1 to 5. As can be seen in these figures, the device 1 comprises:
several, here three separate light sources, 11, 12 and 13,
a beam combiner 6, which comprises the hollow waveguides 21, 22, 23, 40 mentioned hereinabove, and which has here the form of a globally parallelepipedic and flat block, and
the output mirror 9.

The light sources 11, 12, 13 are here laser sources of the QCL type (Quantum Cascade Laser) that each emit a substantially monochromatic radiation (i.e.: of a very narrow spectrum), with an average emission wavelength located between 1 and 15 microns, between 2 and 12 microns or even between 5 and 11 microns. Note moreover that the fact that the beams F1 to F3 are called “light beams” cannot be interpreted as meaning that these beams are visible beams. These three sources have respective average emission wavelengths I₁, I₂ and I₃ that are different from one another, here. Alternatively, the different sources of the device could however have the same emission spectrum.

The light beams F1, F2, F3 that emerge from sources 11, 12, 13 are highly divergent, here. Each one of these beams has for example an opening angle higher than 20 degrees (even higher than 40 degrees). This opening angle can correspond, as here, to the full width (angular) at mid-height of the irradiance profile of the beam considered, in a first section plane comprising the axis of propagation of the beam. In a second section plane containing the axis of the beam, and perpendicular to the first section plane, each one of these beams has here an opening angle higher than 40 degrees. For the digital simulations presented hereinafter, the beams emitted, of a Gaussian profile, more precisely have an opening angle of 30 degrees and of 60 degrees, respectively in this first and this second cutting plane (these are opening angles corresponding to the type of QCLs used here). Alternatively, the sources 11, 12, 13 could however each be provided with a collimation device, such as a microlens, reducing the divergence of the light beam emitted.

Again alternatively, other type of laser sources could be used, for example sources of the ICL type (Interband Cascade Laser), other types of laser diodes (with an external cavity mounting, or not), other types of external or internal cavity lasers or tunable lasers. However, among the various laser sources that can be considered, semiconductor sources will desirably be chosen, for their compactness (one of the objectives being to obtain a compact device).

Incoherent light sources, for example incandescent sources such as silicon carbide bar sources, could also be used instead of the laser sources mentioned hereinabove.

The sources 11, 12, 13 are arranged one after the other, in a line, along an axis x. The light beams F1, F2, F3 are each emitted in a direction that is parallel to the same axis z, axis which, here, is perpendicular to the axis x.

The device 1 comprises a heat management module to remove the heat released by the sources 11, 12, 13, or even to adjust the temperature thereof. This heat management module here comprises a block 5 made from a thermally conductive material, for example metal, on which the sources are mounted (FIG. 1). This block plays both the role of a thermostat (due to its thermal inertia) and a heat dissipator. More generally, the heat management module comprises a thermostat and a heat dissipator (cooling fins, Peltier effect module, etc.). The heat management module is here the same for the different sources (which is well suited when the illumination is done successively for the different sources, or if they have the same emission spectrum). But the device could also include thermal management modules that are independent of one another, with one module for each source.

In this embodiment, the sources 11, 12, 13 are rigidly bound to the waveguides 21, 22, 23, 40, i.e. fixed, without displacement possible with respect to the latter. Indeed, the sources are permanently fixed on the block 5, which itself is rigidly bound to the beam combiner 6 (either because it is fixed to the beam combiner, for example gluing or by screwing, or because the block 5 is formed by a section of a monolithic part that is part of the combiner, this section protruding at the rear of the combiner).

As can be seen in FIG. 2, the waveguides 21, 22, 23, 40 here extend parallel to the same plane P, and are even coplanar. In other terms, each waveguide extends along an average line, on which it is centred, and these different average lines are located in this same plane P. The plane P in question is parallel to the plane containing the axes x and z mentioned hereinabove (while the axis y shown in the figures is perpendicular to the plane P).

The beam combiner 6 can comprise as here a base 7 with a flat upper surface 71 (and parallel to the plane P in question). On its upper surface, this base comprises several grooves. Each waveguide 21, 22, 23, 40 is formed, at least partially, by one of these grooves. These grooves can have any transverse profile, for example triangular, semi-circular, or, as here, rectangular (which is convenient in terms of manufacturing). The beam combiner 6 can also comprise a cover 8 with a lower surface 82, planar, that comes into contact with the upper surface 71 of the base (FIG. 4). It is this lower surface 82, metallic and reflecting, that delimits the upper portion of the waveguides (by covering the grooves in question, or, in other terms, by closing off the upper opening of each groove). This arrangement allows for a convenient manufacturing of the set of waveguides, whether via etching of the upper face of a substrate, machining by removing material, of the milling type, or by additive manufacturing or by moulding. The base 7 is a monolithic part in a single piece (i.e.:

with a continuity of material over the entire part), as well as the cover 8, which contributes to the stability and compactness of the device.

The beam combiner 6, globally parallelepipedic, is of small dimensions. Its width and its length are for example less than 20 or even 10 mm, while its thickness is for example less than 5 mm or even 3 mm.

Whether it is formed by this base and cover, or differently, the beam combiner 6 here comprises a substrate wherein the waveguides 21, 22, 23, 40 are formed. This substrate can be formed from a semiconductor material, such as silicon for example, or from glass, the surfaces that laterally delimit the guides then being covered with a metal layer, after having possibly been polished. This metal layer has a high reflectivity over the entire spectral range of use, for example greater than 95% or even 98%. This metal can for example be aluminium or gold, which each have a high reflectivity in the mid-infrared range. The substrate in question can also be made of metal, which makes it possible to overcome a step of metallisation of the surfaces in question. It can be noted that, in the mid-infrared, a surface roughness of about a few hundred nanometres is largely sufficient to obtain a quality specular reflection, and such a roughness is compatible, in a standard way, with the manufacturing techniques mentioned hereinabove.

Note that, in the case of a semiconductor substrate, all the hollow guides could be carried out by standard microelectronics methods (etching, bonding, metallisation), with this substrate also being used as a support for the light sources (the sources then being semiconductor-based sources). In this way, the alignment (and the packaging) of the different elements would be facilitated.

Regardless of the nature of the substrate wherein the waveguides 21, 22, 23, 40 are a part, each waveguide is entirely delimited laterally by one or more metallic reflecting surfaces, here. Thus, for a waveguide of circular section, for example, the guide is delimited laterally by an entirely metal cylindrical surface. For waveguides that have a straight section that is rectangular, such as those shown in FIG. 2, each guide, or, at the very least, each segment of the guide is delimited laterally by four metallic reflecting surfaces.

As already indicated, the waveguides 21, 22, 23, 40 are hollow. The interior volume of these different guides can be filled with air. It can also be filled with air devoid of water vapour, or pure nitrogen, or put into a vacuum, in order to overcome the marked absorption caused by the water vapour and carbon dioxide at some mid-infrared wavelengths.

The geometrical structure of all the waveguides 21, 22, 23, 40 is now described in more detail.

Each input waveguide 21, 22, 23 extends from its input opening 24, 26, 28 to an output opening 25, 27, 29 through which it leads into the output waveguide 40 (FIG. 2).

The input waveguide 22 is straight, and parallel to the axis z of emission of the light beams F1, F2, F3. The two input waveguides 21 and 23 located on either side of the latter are straight piecewise, with, for each one, a short input segment, parallel to the axis z, and a main segment, straight, titled with respect to the axis z in such a way as to progressively bring this guide closer to the other input waveguides. Alternatively, instead of being straight piecewise, the guides could however be curved (i.e. extend along curved average lines). The input waveguides 21, 22, 23 each have a section, here rectangular, that remains the same all along this guide, without widening or narrowing.

In this first embodiment, each input opening 24, 26, 28 is located in front of, i.e. facing one of the sources 11, 12, 13 of the device 1. The distance between the source considered, 11, 12, 13 and the corresponding input opening, 24, 26 or 28, is reduced, in such a way as to inject most of the emitted beam F1, F2, F3 into the guide despite the strong divergence of this beam. This distance is for example greater than 20 microns (for ease of fabrication), but less than half the width w or the diameter of the input opening 24, 26, 28.

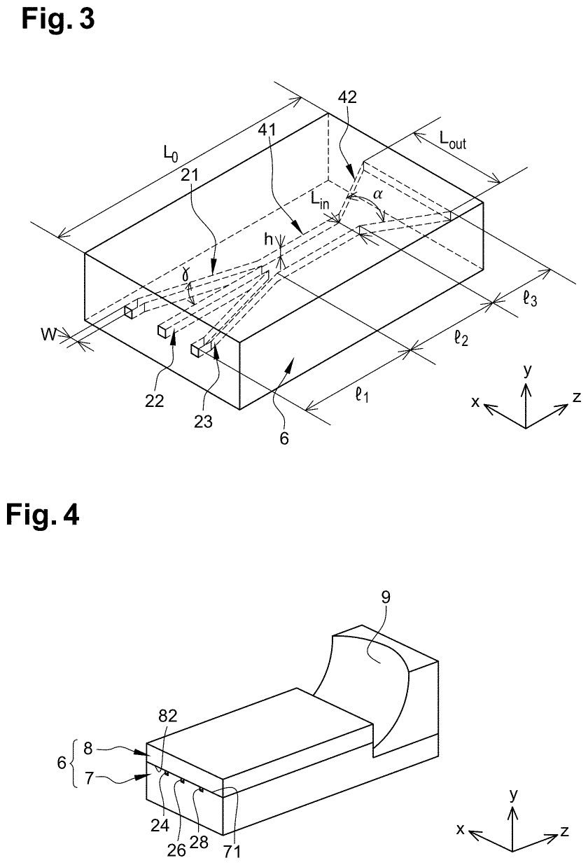

In terms of lateral dimensions, the input waveguides 21, 22, 23 have:
a height h (extension according to a direction perpendicular to the plane P) which is the same for these different guides, and which is moreover equal to the height h of the output waveguide 40 (FIG. 3), and
the same width w.

The height h and the width w are greater than 0.1 mm. This renders the alignment of the sources and of the input waveguides relatively easy, and allows for an injection with little loss. Using waveguides that are not too narrow also makes it possible to limit the number metal reflections on the edges of the guide, which makes it possible to reduce the losses by absorption on the metal surfaces that delimit the guide. Moreover, the height h and the width w are less than 1.5 mm, and even less than 0.7 mm, here, in such a way as to limit the total size of the device 1.

Regarding the output waveguide 40, it extends from a first end 43 to its output opening 45.

The input waveguides 21, 22, 23 are connected to the output waveguide 40 at its first end 43. At its first end 43, the output waveguide has moreover a width close to three times the width w of any one of the input guides.

The output waveguide 40 is centred on an axis zo, here parallel to the axis z. The input waveguide 22 is aligned with the axis zo of the output waveguide 40. The two input waveguides 21 and 23 are connected to the output waveguide 40 by forming an angle γ with the axis zo of this guide. The junction angle y is comprised in an embodiment between 10 and 50 degrees (including when the number of input guides is different from that used here).

As can be seen in FIG. 2, the output waveguide 40 comprises a junction section, 41, followed by a divergent section 42.

The junction section 41 extends from the first end 43 of the output waveguide, to an input section 44 of the divergent section 42 (this input section is the section of the guide 40 from which it widens). The junction section 41 has a section that remains the same all along the junction section 41 (section which, here, is rectangular).

The divergent section 42 extends from its input section 44 to the output opening 45 of the output waveguide. It here has a rectangular section (rectangular profile, or, in other words, rectangular contour), that widens all along this section 42 of the output guide. This divergent section is thus delimited by four surfaces planes 46, 47, 48, 49 that together form a horn that widens when moving towards the output of the guide.

Here, the upper and lower surfaces 48, 49 of this horn are parallel with each other, and parallel to the plane P. Its two lateral surfaces 46 and 47 are on the other hand tilted with respect to one another. They form between them an opening angle α. This opening angle is here higher than 20 degrees, and even 50 degrees, and lower than 100 degrees. For the connecting angles of the input waveguides 21, 22, 23 on the output waveguide 40 comprised typically between 10 and 50 degrees, such opening angle values are well suited for obtaining as the output a global light beam F0₁ wherein the averaged directions of propagation of the initial individual light beams F1, F2, F3 will have been brought closer to one another.

Here, the divergent section 42 is therefore divergent only in one plane. This plane, wherein the output waveguide 40 is angularly open, is the same as the plane containing the input waveguides, angularly separated from one another (this is the plane P mentioned hereinabove), precisely so that the angular opening of the output guide makes it possible to bring the directions of propagation of the beams closer together, injected into this guide by the input guides.

In terms of profile, the output opening 45 of the output guide has an area that is at least higher than twice, or even higher than three times the area of the input section 44 of the divergent section 42 of the output guide. This increase in surface makes it possible to substantially reduce the divergence of the global light beam F0₁ that emerges from the beam combiner 6.

Several alternatives can be considered, for the output waveguide 40 that has just been presented.

Thus, the junction section 41, non-divergent, could for example be omitted. Other digital simulation results show indeed that a satisfactory combination can be obtained without this junction section (to the point of modifying the dimensions or the opening angle of the output guide), in particular in terms of divergence of the global output light beam and of homogeneity of the light power in the latter.

The junction section 41 could also be slightly divergent (but less than the divergent portion 42), to favor a propagation of the beams in the direction of the output of the device.

Instead of comprising a non-divergent section, followed by a divergent section that has a constant opening angle, the output waveguide could have an opening angle that varies progressively, continuously all along this guide (this opening angle increasing for example progressively along this guide). In this case, the output waveguide would then have an average opening angle (average along the divergent section, from its input section to the output opening) higher than 20 degrees, or even 40 degrees.

On the other hand, instead of being divergent according to a single one of the two transversal directions perpendicular to the axis zo of the guide (here according to the direction x), the divergent section 42 could be divergent according to these two transversal directions (x and y). The divergent section could then have the shape of a cone, or the shape of a horn with four faces such as presented hereinabove but then with upper and lower surfaces 48 and 49 also tilted with respect to one another (instead of being parallel).

Moreover, the device could comprise a number of input waveguides different from what was presented hereinabove (for example four or five input guides, instead of three).

Now concerning the output mirror 9, as already indicated, it is tilted in such a way as to deviate the global light beam F0₁ that emerges from the output opening 45, towards a zone to be illuminated Zs located outside the axis.

Here, the output mirror 9 is tilted in such a way that the global light beam F0₁ has an averaged direction of propagation z_{R}, after reflection on the output mirror 9, that is perpendicular, or almost perpendicular to the plane P. This makes it possible to illuminate the zone Zs, located outside the axis (shifted apart).

Being able to illuminate such a zone is interesting in practice for the device 1, which is miniaturised and portable. Indeed, the beam combiner 6, globally planar and that remains one of the most sizeable elements of the device, can then be placed parallel to the surface of an element to be characterised, such as the skin of an individual or a block of material to be analysed, the output mirror then deflecting the global light beam towards this surface to be analysed (with an illumination that is globally in normal incidence).

The zone to be illuminated Zs corresponds here to a disc, the diameter of which is comprised between 1 and 10 mm, parallel to the plane P.

As already indicated, the output mirror 9 is convergent, in order to reduce the divergence of the global light beam F0₁. The convergent nature of this mirror makes it possible in particular to increase the total light power received in the zone to be illuminated Zs.

By way of example, the output mirror 9 can be a parabolic mirror used outside the axis (the reflecting surface of which being formed by a portion of a paraboloid).

The output mirror could also be a mirror of the parabolic type, but with parabolic profiles and focal points that are different in a section plane parallel to the plane y,z, and in a section plane parallel to the plane x,z. The output mirror could also be a mirror of the toroidal type (circular section, but with different radii of curvature in the plane of the sources, x,z, and in the plane y,z). The output mirror could also have a concave reflecting surface with an arbitrary shape (“freeform” mirror), optimised to illuminate essentially the zone Zs, homogeneously.

In any case, the more or less convergent nature of the output mirror 9 (its focal distance, for example), and the position of this mirror are determined in such a way as to optimise the power received in the zone Zs and/or the homogeneity with which this power is distributed in the zone Zs (and this possibly beam by beam, when the sources have different emission spectra) and/or the collimated nature of the global light beam F0₁.

The characteristics of the output mirror are in general chosen according to those of the divergent output waveguide 40, since the characteristics of the divergent section of this guide have a substantial influence on the properties of the global light beam that emerges from the guide. By way of example, for a highly divergent guide, the focal point of the output mirror can be chosen closer to the input section 44 than the output opening 45 of the waveguide, and inversely for a hardly divergent guide.

Values that are well suited for the curvature of the output mirror 9, for its position, as well as for the geometrical characteristics of the waveguides (opening angle, length of each section, etc . . . ) can be determined, by digital simulation, for example by plotting rays, in such a way as to optimise one or more of the criteria mentioned hereinabove.

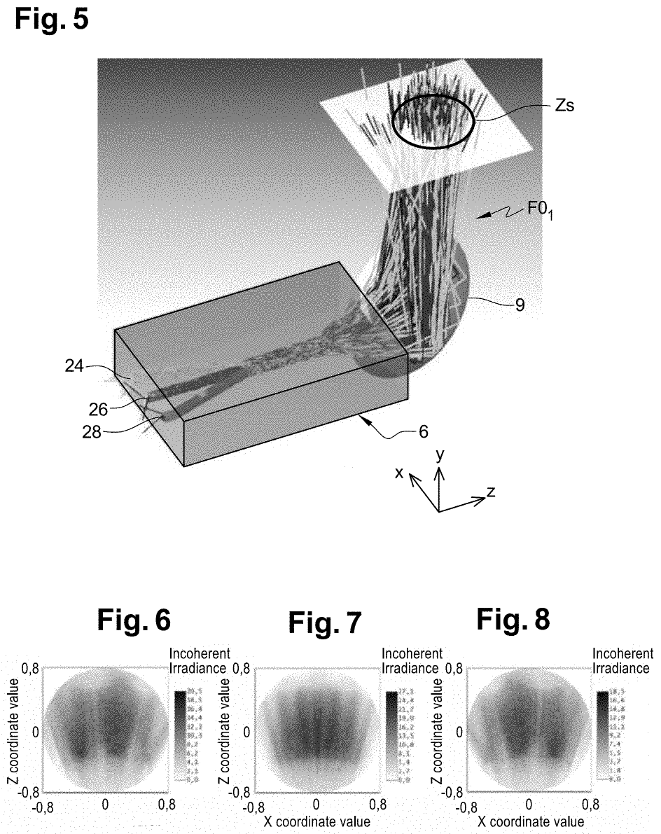

An example of a result of such a simulation is presented in FIGS. 5 to 8.

In this example, the fixed parameters were: the height h of the waveguides (0.2 mm), the width w of the input waveguides (0.18 mm), the spacing between the sources (0.86 mm), and the total length Lo of the beam combiner (about 6 mm). The zone Zs to be illuminated has a diameter of 1.6 mm and is located 6 mm above the plane of the (according to the Y axis).

The (adjustable) free parameters comprised: the length I3 and the width Lout of the divergent section of the output waveguide, the length I2 of the junction section 41, the length according to the axis z of the input guides, I1, and the position and focal point of the output mirror 9.

The free parameters were then adjusted by carrying out digital simulations (using the optical simulation software Zemax OpticStudio), in such a way as to optimise the total power received in the zone Zs as well as the homogeneity with which this power is distributed in the zone Zs and this, beam by beam (i.e. with only the beam F1 present as input, then with only the beam F2 present as input, then with only the beam F3 present as input).

The results shown in FIGS. 5 to 8 are those obtained at the end of this optimisation procedure. For this example, this optimisation procedure led to the following values: connecting angle γ of about 17 degrees, opening angle a of about 60 degrees (the width Lout of the output opening 45 being equal to about 4.4 times the width Lin of the input section 44), I2/Lo ratio of about ⅓, radius of curvature of the output mirror of about 3 mm, the mirror having a diameter of 4 mm and being tilted 45 with respect to the plane P.

FIG. 5, which shows a portion of the light beams plotted during this simulation, shows that most of the rays emitted effectively contribute to the illumination of the zone Zs, few rays passing outside this zone. More precisely, for the three light sources 11, 12 and 13, the total light power received in the zone Zs is respectively 45% (for the source 11), 57% and 42% of the light power initially emitted by the considered source. The slight difference in energy efficiency between the channel of the source 11 and that of the source 13 (although these two channels are symmetrical with one another) can be explained by a slight stronger absorption of the metal used (here gold) at the wavelength I3 (of about 9 microns), with respect to the wavelength I1 (of about 6 microns).

FIG. 6 shows, in grayscale, the irradiance obtained at different points of the zone Zs when only the source 11 is in operation (the sources 12 and 13 being switched off). The coordinates x and z that mark the point considered inside this zone, are expressed in mm, in this figure. FIG. 7 and FIG. 8 are identical to FIG. 6, but correspond respectively to the case where only the source 12 is in operation, and to the case where only the source 13 is in operation. As can be seen in these figures, the light power is effectively distributed homogeneously inside the zone Zs to be illuminated, and this for each source. As can be seen in FIGS. 10 to 12, things would be very different without the divergent section of the output waveguide.

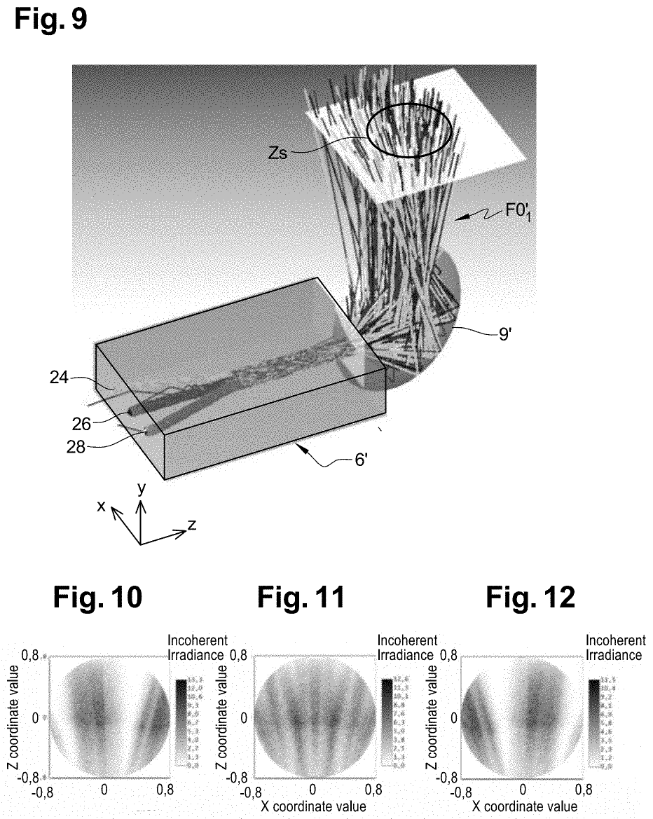

FIGS. 9 to 12 show the results of a digital simulation carried out in the same conditions as for FIGS. 5 to 8, but without a divergent section at the output of the output waveguide. The beam combiner 6′ then comprises the three input waveguides mentioned hereinabove, and an output waveguide with a constant section.

As hereinabove, the characteristics of the output mirror 9′ (as well as a portion of the geometrical characteristics of the guides) were adjusted in such a way as to optimise the total power received in the zone Zs as well as the homogeneity with which this power is distributed in the zone Zs, and this, beam by beam.

But as can be seen in FIG. 10, FIG. 11 and FIG. 12, even with this optimisation procedure, a hardly homogeneous illumination of the zone Zs is then obtained, in particular for the light coming from the source 11, or 13.

It is observed moreover in FIG. 9 that a substantial proportion of the light rays emitted then pass outside the zone Zs (despite the output mirror 9′, convergent) and do not participate in the illumination thereof. Moreover, for the three light sources 11, 12 and 13, the total light power received in the zone Zs is then respectively 18% (for the source 11), 23% and 16% of the light power initially emitted by the considered source.

These results illustrate the interest, for such a device for combining beams, of using an output waveguide that widens in the direction of propagation of the beams (instead of narrowing or retaining a constant section), when it is sought to produce at the output a global pseudo-collimated light beam and/or with a high and homogeneous light power density.

### Second Embodiment

The device 2 of the second embodiment, shown in FIG. 13, is identical to the device 1 of the first embodiment, but it is devoid of the output mirror presented hereinabove.

Its beam combiner 62 has the same structure as the combiner 6 of the first embodiment. Some dimensional characteristics of the device 2, such as the length and the opening angle of the divergent section 42 of the output waveguide 40, can however have different values, with respect to the first embodiment, in such a way as to obtain a global light beam F0₂ as homogeneous and collimated as possible despite the absence of a convergent mirror at the output.

Moreover, as hereinabove, some dimensional characteristics of the device 2 can be adjusted by digital simulation, in such a way as to optimise the total power received in a given zone to be illuminated, and/or the homogeneity with which this power is distributed in this zone, for this device without an output mirror.

### Third Embodiment

The device 3 of the third embodiment is identical to the device of the first embodiment, but it is devoid of an output mirror (whether a convergent mirror, or simply a tilted flat mirror). On the other hand, it comprises one input mirror 51, 52, 53 for each input light beam F1, F2, F3 (FIG. 14), so as to direct these light beams towards the input waveguides 21, 22, 23. Indeed, in this embodiment, the sources 11, 12, 13 have emission directions that are tilted with respect to the plane P wherein the waveguides extend, and even perpendicular to this plane.

These tilted input mirrors, 51, 52, 53, make it possible to thus dispose the sources 11, 12, 13, with their emission directions out of plane. This provides additional flexibility in the overall configuration of the device 3, and can in particular facilitate the installation of the cooling and/or thermalisation system of the sources.

In the present configuration, where the sources 11, 12, 13 are rather separated from the input openings of the input waveguides, it can be interesting to use sources each provided with a collimation system (collimation lens, microlens, etc.), in order to reduce the divergence of the light beams F1, F2, F3 that emerge therefrom. This then makes it possible to retain rather small dimensions for the input openings of the guides (less than 1.5 mm, for example, to retain a compact device 3), while still injecting most of each beam F1, F2, F3 into the corresponding input guide. Alternatively or as a supplement, input mirrors 51, 52, 53 could moreover be used that are both tilted and convergent, instead of providing the sources with collimation systems.

Again alternatively, instead of comprising several separate input mirrors, one per source, the device could comprise only one input mirror, in a single piece, which is the same for the different sources.

In any case, the beam combiner 63 of this device 3 has the same structure as the combiner 6 of the first embodiment. But here too, some dimensional characteristics of the device 3, such as the length and the opening angle of the divergent section 42 of the output waveguide 40, can have different values, with respect to the first embodiment, in such a way as to obtain a global light beam F03 as homogeneous and collimated as possible, despite the absence of a convergent mirror at the output, and in light of the divergence that is possibly different of the individual light beams, F1, F2, F3, that enter the device 3. As hereinabove, some dimensional characteristics of the device 3 can be adjusted by digital simulation, in such a way as to optimise the total power received in a given zone to be illuminated, and/or the homogeneity with which this power is distributed in this zone.

Various alternatives can be made to the embodiments that have just been presented, in addition to those already mentioned. By way of example, the device could comprise both an output mirror, such as described hereinabove, and one or more input mirrors. Moreover, the sources could emit in other wavelength ranges than the one mentioned hereinabove, for example in the visible range.

1. A device for combining a plurality of light beams, the device comprising a plurality of hollow input waveguides, at least one for each light beam, as well as a hollow output waveguide which is the same for the plurality of light beams,
each hollow input waveguide having an input opening to let a corresponding light beam of the plurality of light beams enter, and, at an opposite, an output opening, the hollow input waveguide leading to the hollow output waveguide through the output opening of the hollow input waveguide,
the hollow output waveguide, and each hollow input waveguide being laterally delimited by one or more metallic reflecting surfaces,
wherein at least a section of the hollow output waveguide is divergent and widens when moving towards an output opening of the hollow output waveguide.

2. The device according to claim 1, further comprising a convergent mirror on which said plurality of light beams reflect, after emerging from the hollow output waveguide.

3. The device according to claim 1, wherein said divergent section has an average opening angle (α) greater than 20 degrees.

4. The device according to claim 1, wherein the output opening of the output hollow waveguide has an area that is at least greater than twice an area of an input section of said divergent section.

5. The device according to claim 4, wherein the output opening of the output hollow waveguide has an area that is at least greater than three times an area of an input section of said divergent section.

6. The device according to claim 1, wherein the plurality of hollow input waveguides and the hollow output waveguide each extend parallel to a same plane.

7. The device according to claim 6, further comprising a deflecting mirror arranged to reflect the plurality of light beams emerging from the hollow output waveguide in an averaged direction tilted with respect to said plane.

8. The device according to claim 6, comprising a base with an upper surface, and a cover with a lower surface that is in contact with the upper surface of the base, the base comprising, on its upper surface several grooves, each hollow input waveguide being formed, at least partially, by one of said grooves.

9. The device according to claim 1, comprising a plurality of light sources for emitting said plurality of light beams, each light source being placed so that the light beam emitted by said light source enters one of the hollow input waveguides of the device, and wherein said plurality of light sources are rigidly bound to the hollow input waveguides.

10. The device according to claim 9, wherein the plurality of hollow input waveguides and the hollow output waveguide each extend parallel to a same plane, and wherein the device further comprises at least one input mirror, to reflect the light beam emitted by one of said plurality of light sources towards the input opening of the corresponding hollow input waveguide, a direction perpendicular to said at least one input mirror being tilted with respect to said plane (P).

11. The device according to claim 1, wherein at least some of the hollow input waveguides have a section whose width or diameter is between 0.1 and 1.5 mm.

12. The device according to claim 11, wherein the width or diameter is between 0.1 and 0.7 mm.
